(19) United States
(12) Patent Application Publication
(10) Pub. No.: US 2013/0317246 A1
(43) Pub. Date: Nov. 28, 2013

(54) METHOD FOR THE PURIFICATION OF BIPHEPHOS

(71) Applicants: Burkard Kreidler, Essen (DE); Dirk Fridag, Haltern am See (DE); Bernhard Schemmer, Haltern am See (DE); Bjoern Wechsler, Borken (DE); Andrea Christiansen, Neu-Ulm (DE); Doris Neumann, Offenbach a.M. (DE)

(72) Inventors: Burkard Kreidler, Essen (DE); Dirk Fridag, Haltern am See (DE); Bernhard Schemmer, Haltern am See (DE); Bjoern Wechsler, Borken (DE); Andrea Christiansen, Neu-Ulm (DE); Doris Neumann, Offenbach a.M. (DE)

(73) Assignee: Evonik Oxeno GmbH, Marl (DE)

(21) Appl. No.: 13/979,524

(22) PCT Filed: Dec. 22, 2011
(86) PCT No.: PCT/EP11/73771

§ 371 Date: Aug. 14, 2013

(30) Foreign Application Priority Data
Jan. 13, 2011 (DE) 10 2011 002 640.1

(51) Int. Cl. C07F 9/6574

(52) U.S. Cl. CPC C07F 9/65746
USPC 558/77

(57) ABSTRACT

The invention relates to a process for the purification of 6,6′-[(3,3′-di-tert-butyl-5,5′-dimethoxy-1,1′-biphenyl-2,2′diyl)bis(oxy)]bis(dibenzo[d,f][1,3,2]dioxaphosphepin), abbreviation: biphephos (see formula 1).

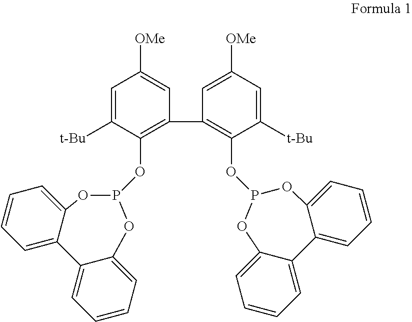 [SMILES: COc1cc(-c2cc(OC)cc(C(C)(C)C)c2Op2oc3ccccc3c3ccccc3o2)c(Op2oc3ccccc3c3ccccc3o2)c(C(C)(C)C)c1]

The invention relates to a process for the purification of 6,6′-[(3,3′-di-tert-butyl-5,5′-dimethoxy-1,1′-biphenyl-2,2′diyl)bis(oxy)]bis(dibenzo[d,f][1,3,2]dioxaphosphepin), abbreviation: biphephos (see formula 1).

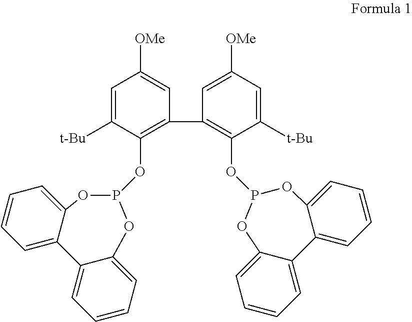 [SMILES: COc1cc(-c2cc(OC)cc(C(C)(C)C)c2Op2oc3ccccc3c3ccccc3o2)c(Op2oc3ccccc3c3ccccc3o2)c(C(C)(C)C)c1]

Biphephos is a ligand which has found widespread use in transition-metal-catalysed reactions. Biphephos is used, for example, in the transition-metal-catalysed hydroaminomethylation (E. Petricci, A. Mann, J. Salvadori, M. Taddei, Tetrahedron Letters 2007, 48, 8501-8504), the hydrocyanation (U.S. Pat. No. 5,449,807), the hydroformylation (U.S. Pat. No. 4,769,498, CN1986055), the isomerisation (U.S. Pat. No. 5,440,067) and the cyclohydrocarbonylation (U.S. Pat. No. 5,962,744) of olefins.

Biphephos is usually prepared in three synthesis steps from commercially available starting materials: to produce the backbone, 3-tert-butyl-4-hydroxyanisole is reacted oxidatively to give the biaryl compound 3,3′-tert-butyl-2,2′-dihydroxy-5,5′-dimethoxybiphenyl. To produce the side wings, phosphorus trichloride is reacted with 2,2′-dihydroxybiphenyl in order to form 6-chloro-dibenzo[d,f][1,3,2]-dioxaphosphepin (see formula 2). Finally, the reaction products of the two steps are condensed with one another in the presence of a base to give biphephos.

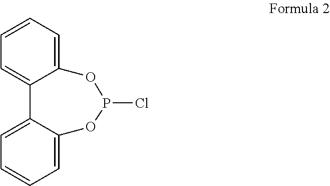 [SMILES: Clp1oc2ccccc2c2ccccc2o1]

The most extensive use of biphephos consists in the hydroformylation of propene to n-butyraldehyde. In this process, propene is reacted in the presence of rhodium as catalyst metal and biphephos as ligand with hydrogen and carbon monoxide. For the reaction, pressurized reactors made of steel are usually used. These reactors are very sensitive to traces of hydrogen chloride, which can form from chloride ions in the presence of transition metals and elemental hydrogen. In the presence of chloride ions, stress-crack corrosion is a threat which, in the more favourable case, can result in a premature shut down and overhaul of the reactor, but in the worst case scenario can result in rupture of the reactor.

The introduction of chloride ions via the olefin or the synthesis gas can be suppressed by steps known to the person skilled in the art (e.g. absorber beds). When adding the catalyst metal, it is advisable to use a chlorine-free species, for example rhodium ethylhexanoate or Rh(acac)(CO)₂.

Since biphephos is ultimately formed from PCI₃, special efforts have to be made in order to prepare biphephos that contains the lowest possible content of chloride. In the case of the hydroformylation of propene, relatively high chlorine contents are less critical since only a slight degradation of biphephos takes place at the temperatures required therein. However, during the hydroformylation of higher olefins, higher temperatures are generally required, and these bring about an increased rate of degradation of biphephos. This means that in a continuously operating hydroformylation process, the continual degradation of biphephos has to be compensated for by topping up with fresh biphephos. If, then, biphephos contains traces of chloride, this means that chloride gradually accumulates in the reactor since chloride is practically not discharged from the reactor. As the chloride content increases, the risk of stress-crack corrosion consequently increases considerably.

It is therefore important to develop a production and purification process for biphephos which provides biphephos with a low chloride content. The chloride content can be determined easily by analytical means; for example by aqueous titration. More far reaching is the determination of the total chlorine content which, besides the chlorides, also includes chlorine bonded in other ways. Focussing on the total chlorine content is also helpful in so far as it cannot be ruled out that chlorine bonded in other ways is able to damage the reactor. When calculating the limiting values for total chlorine, however, the chloride fraction remains decisive. The ready-to-use biphephos should contain less than 2000, preferably less than 1000, particularly preferably less than 500 and very particularly preferably less than 100 ppm of total chlorine. For a total chlorine content within this order of magnitude, in processes carried out industrially, the risk of stress-crack corrosion in the reactor can be controlled.

A suitable method for determining the total chlorine content is the combustion in accordance with Wickbold; with sample preparation according to DIN 51408 and measurement by ion chromatography according to DIN EN ISO 10304.

In a parallel paper, a cost-effective and technically simple-to-carry out synthesis method for biphephos was developed in which 3,3′-tert-butyl-2,2′-dihydroxy-5,5′-dimethoxybiphenyl is reacted with 6-chlorodibenzo[d,f][1,3,2]-dioxaphosphepin in a solvent mixture comprising acetonitrile. In this, biphephos can be obtained with a low chlorine content of less than 5000 ppm and in a high yield.

It is desirable to further reduce this already low chlorine content by means of a subsequent work-up.

It is known from J. Am. Chem. Soc. 1993, 115, 2066-2068 that biphephos can be recrystallized from acetonitrile. However, the inventors have surprisingly found that even small traces of remaining acetonitrile can adversely affect the storage stability of biphephos to a considerable degree (see Example 3).

It was then an object of the present invention to develop a purification method in which the chlorine content of biphephos with a chlorine content of more than 1000 ppm to 5000 ppm can be reduced to a chlorine content of less than 500 ppm, preferably of less than 250 ppm and particularly preferably of less than 100 ppm, and where storage-stable, in particular acetonitrile-free, biphephos is obtained. The stated chlorine contents are total chlorine contents.

This object is achieved by a process for the purification of biphephos, characterized in that the biphephos is washed out with a solvent selected from the group comprising ethyl acetate, anisole, ortho-xylene, toluene, acetone, 2-propanol and C5-C10-alkanes or mixtures thereof or with a solvent mixture comprising one or more of these solvents and/or is recrystallized from such a solvent or solvent mixture. C5-C10-Alkanes are in particular pentane, hexane, heptane, octane, nonane and decane. From the alkanes, n-heptane is preferred. Preferably, the biphephos is recrystallized from a solvent selected from the group comprising ethyl acetate, anisole, ortho-xylene, toluene, acetone, 2-propanol and C5-C10-alkanes or mixtures thereof.

“Washing out” involves the suspension, and possibly partial dissolution, of the biphephos in a solvent or solvent mixture and the subsequent removal of the biphephos from the solvent or solvent mixture.

“Recrystallization” involves the dissolution in a solvent or solvent mixture and the subsequent precipitation or crystallizing out of the biphephos from this solvent or solvent mixture. It is thus not absolutely necessary that defined crystals of biphephos are formed. The precipitation of biphephos from supersaturated solution suffices to be classed as recrystallization.

In a particularly preferred embodiment of the process according to the invention, the solvent or solvent mixture is acetonitrile-free.

“Solvents” are to be understood here as meaning only the substances actually used as solvents, i.e. the compounds liquid at 23° C. from which the recrystallization is to take place. The solvents thus, for example, do not include acetonitrile or bases, such as e.g. pyridine, which are still present as residues in the biphephos prior to the purification.

“Acetonitrile-free” accordingly means that the solvents used do not contain acetonitrile. Any residues of acetonitrile which are present in the biphephos prior to its purification should therefore be harmless for establishing whether the solvent or solvent mixture is or is not acetonitrile-free. Under laboratory conditions, ethyl acetate, toluene, xylene such as ortho-xylene, C5- to C10-alkanes and acetone, in particular, are obtainable acetonitrile-free. Since the boiling points of these solvents are sufficiently distant from the boiling point of acetonitrile, a qualitative separation by distillation is to be effected. In industrial processes, however, it is usual to recycle solvents, meaning that traces of acetonitrile can accumulate in the solvent via the recyclate, and these traces adversely affect the storage stability of the biphephos. Ultimately, it is a question of economics, to what extent traces of acetonitrile in the solvent are tolerable, what measures are taken to eliminate acetonitrile from the solvent, and/or what losses in storage stability are accepted. Within the context of the invention, the acetonitrile content in the solvent is to be minimized, with priority being given to the economics; ideally, it is acetonitrile-free. A preferred embodiment of the invention therefore provides measures for keeping the solvent as free as possible from acetonitrile, to remove it in particular by distillation from the solvent.

In a preferred embodiment of the process according to the invention, the biphephos is dissolved, preferably with heating, in the solvent or solvent mixture, insoluble constituents are removed by filtration, preferably at a temperature up to 130° C., and the biphephos is then precipitated out or crystallized out by cooling the solvent or solvent mixture. Optionally, by adding a C5-C10-alkane, e.g. pentane, hexane, heptane, n-heptane, octane, nonane or decane, further biphephos can be precipitated out or crystallized out.

The dissolving of the biphephos to be purified typically takes place by heating the preferably acetonitrile-free solvent or solvent mixture. Subsequently, it can then be cooled to room temperature or lower. In a particularly preferred embodiment of the process according to the invention, the solvent or solvent mixture in which the biphephos is dissolved has a temperature of more than 50° C. The insoluble constituents are then preferably removed by hot filtration.

In a particularly preferred embodiment of the process according to the invention, the biphephos prior to the recrystallization has a total chlorine content of up to 5000 ppm or more, preferably up to 4000 ppm, further preferably up to 3000 ppm, and particularly preferably up to 2000 ppm. After the recrystallization, low-chlorine biphephos with a total chlorine content of less than 500 ppm, preferably less than 250, further preferably less than 100 ppm, and particularly preferably less than 50 ppm can be obtained. The low-chlorine biphephos obtained according to the invention is, moreover, acetonitrile-free and storage-stable. When determining the total chlorine content by the combustion method in accordance with Wickbold, the sample preparation is in accordance with DIN 51408 and the measurement is in accordance with DIN EN ISO 10304 (by ion chromatography).

The purification process according to the invention thus permits biphephos with a very low content of chlorine/chloride to be provided. Moreover, it is possible to work with considerably smaller amounts of solvent than is the case when using acetonitrile (cf. Example 4).

In a particularly preferred embodiment of the process according to the invention, the biphephos is recrystallized from a solvent mixture comprising up to 20% by weight of n-heptane and at least 50% by weight of ortho-xylene. Optionally, by adding further n-heptane, the yield of recovered biphephos can be increased.

According to a likewise preferred alternative, the biphephos can be recrystallized from a solvent mixture comprising up to 10% by weight of n-heptane and at least 90% by weight of ethyl acetate.

After recrystallization has taken place, the biphephos can be isolated. This typically takes place by filtering off and, optionally, drying the filtered-off biphephos.

The present invention further provides the use of ethyl acetate, anisole, ortho-xylene, toluene, acetone, 2-propanol or a C5-C10-alkane or mixtures thereof as solvent or as constituent of a solvent mixture in a process for the purification of biphephos by washing out and/or recrystallization. C5-C10-Alkanes are in particular pentane, hexane, heptane, octane, nonane and decane. From the alkanes, n-heptane is preferred.

### EXAMPLES

### Example 1

### Preparation of Biphephos

In a glovebox, 17.5 g (0.063 mol) of phosphorochloridite, prepared as in DE-A102008043584, is introduced as initial charge in 110 ml of acetonitrile (Fluka) in a 250 ml Schlenk flask. Furthermore, 10.4 g (0.028 mol) of 3,3′-tert-butyl-2,2′-dihydroxy-5,5′-dimethoxybiphenyl, were prepared as in EP35965. The latter was dissolved in 17 ml (16.4 g, 0.204 mol) of pyridine and poured into a 100 ml dropping funnel. Said funnel was placed on the Schlenk flask. The apparatus was removed from the glovebox and the Schlenk flask cooled to −10° C. Then, with vigorous stirring, the biphenol/pyridine solution was slowly added dropwise over the course of 2.5 h, during which a solid precipitated out. Following the complete addition, the mixture was after-stirred overnight at −10° C. The solid was then filtered off over a G3 protective-gas frit. The solid was then slurried on the frit under protective gas in 30 ml of acetonitrile and then filtered again. The colourless solid was dried for 16 hours at 10⁻¹ mbar and then analysed. 19.92 g (87.3% of theory) of biphephos were obtained. This comprised 2500 ppm (±100 ppm) of total chlorine (analysis method: combustion in accordance with Wickbold).

### Example 2

### Recrystallization of Biphephos

11.97 g of biphephos, prepared as in Example 1, were suspended in 63.6 ml of o-xylene (Acros) and 7.4 ml of n-heptane (Aldrich) and heated to 100° C. The hot solution was then filtered over a G3 protective-gas frit, giving a clear solution. 35 ml of n-heptane were then added and the mixture was cooled overnight, during which solid precipitated out. The precipitation was completed by adding a further 70 ml of n-heptane, and the solid obtained was filtered off over a G3 protective-gas frit. The substance was dried for 16 hours at 10⁻¹ mbar and analysed. 10.41 g of recrystallized biphephos were obtained. The mass loss was 13%. The substance was investigated as to its total chlorine content in accordance with Wickbold. 35 mg/kg (±5 mg/kg) of total chlorine were found, corresponding to 35 ppm.

### Example 3

### Storage Stability of Biphephos, Comprising Residual Solvent

12 g of biphephos, prepared according to Example 1 and recrystallized according to Example 2, were homogenized in a mortar and then divided into 4 parts each of 3 grams and in each case placed into a 100 ml Schlenk vessel of identical design with a 2 cm magnetic stirrer rod. The Schlenk vessel was then evacuated to 10⁻¹ mbar and filled with argon.

Then, in each case 100 ml of the following solvent (mixtures) were prepared: a) ethyl acetate (Aqura), b) acetonitrile (Promochem), c) anisole/heptane (3/2) (anisole: Sigma-Aldrich, heptane: Sigma-Aldrich), d) o-xylene/heptane (3/2) (o-xylene: Sigma-Aldrich, heptane: Sigma-Aldrich).

All of the solvent (mixtures) were rendered inert in the following way: argon was fed into the particular solvent (mixture) through a glass tube with glass frit at an overpressure of 200 mbar for 30 minutes in each case.

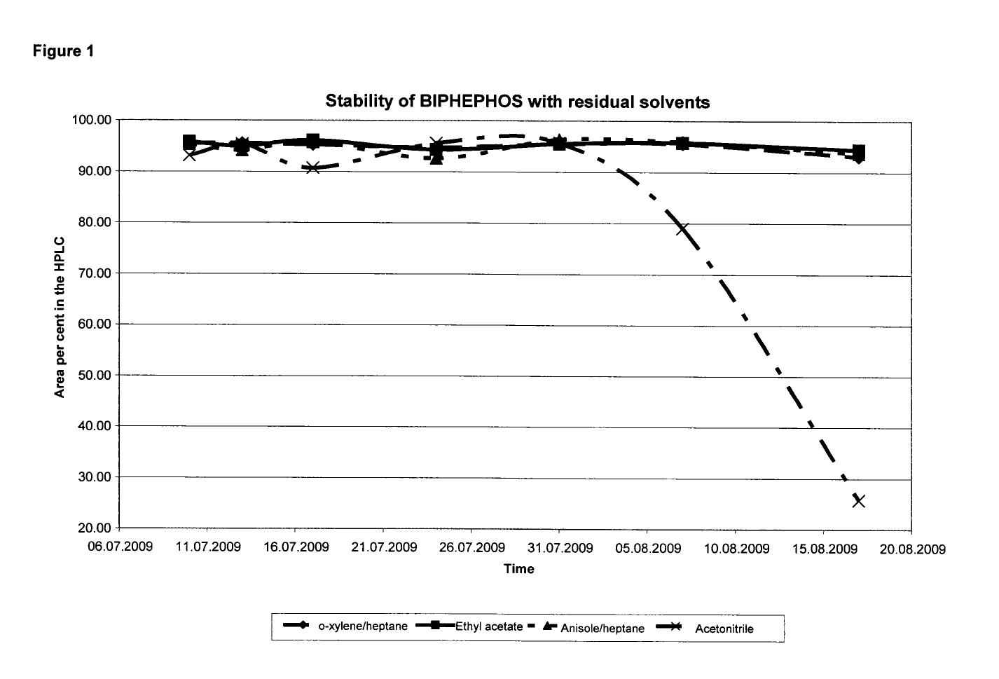

Then, in each case 50 ml of one of the above solvent (mixtures) were added to one of the 4 biphephos samples. Each sample was stirred for 30 minutes at 1100 revolutions per minute using a magnetic stirrer at 23° C. The biphephos was then allowed to settle in each case for 30 minutes and the supernatant liquid was decanted off under protective gas. The residue was dried in each case for 70 hours in vacuo at 10⁻¹ mbar at 23° C. in order to keep traces of residual solvent to a minimum. The samples were then stored in air in the respective Schlenk vessel alongside one another standing upright in a beaker and investigated with regard to the decomposition of biphephos by means of high-performance liquid chromatography (HPLC). For this purpose, in each case 4.5 mg of the biphephos were taken, dissolved in 1 ml of tetrahydrofuran distilled over potassium/benzophenone under argon, and analysed by means of HPLC (see FIG. 1: HPLC analysis of biphephos samples).

It can be seen from FIG. 1 that although all of the samples were prepared in an identical way and the residual solvent content was reduced to a minimum by evacuation for several days, the sample stirred into acetonitrile has a considerably lower storage stability than the samples stirred into other solvents (mixtures).

### Example 4

### Recrystallization of Biphephos (Not According to the Invention)

10 g of biphephos were slurried in 200 ml of acetonitrile (Fluka) under an argon atmosphere in a Schlenk flask with reflux condenser and dropping funnel. The mixture was then heated to boiling in an oil bath. No significant dissolution process could be observed. Additional acetonitrile was then slowly added dropwise. Following the dropwise addition of 260 ml of acetonitrile (total amount of acetonitrile 460 ml), complete dissolution was achieved. Upon cooling, biphephos slowly precipitated out again. It is found that a recrystallization of large amounts of biphephos from acetonitrile can only take place with immense, economically and ecologically irresponsible amounts of solvent.

### Example 5

### Recrystallization of Biphephos

100 g of biphephos, prepared as in Example 1, were suspended in 500 g of ethyl acetate. The mixture was then heated to boiling. 1 g of activated carbon was added, and the hot mixture was filtered over a G3 glass frit. The mother liquor was then left to cool to room temperature, during which biphephos precipitated out. This was filtered off over a further G3 glass frit and after-washed with 50 ml of ethyl acetate. The biphephos obtained was then dried in a vacuum drying cabinet. 75 g of biphephos with a total chlorine content of<100 ppm were obtained.

### Examples 6 and 7

### Recrystallization of Biphephos

As Example 5, except the filtration aid used was 2 g of kieselguhr (Example 6) or 2 g of cotton (Example 7) instead of 1 g of activated carbon. The results were identical to those in Example 5.

### Example 8

2 g of biphephos, prepared as in Example 1, were suspended in 15 ml of 2-propanol and stirred for 15 min. at room temperature. The solid was then filtered off over a G3 protective-glass frit and after-washed with 15 ml of 2-propanol. The colourless solid was dried for 16 hours at 10⁻¹ mbar and then analysed. 1.64 g of biphephos were obtained with a total chlorine content of 77 ppm.

### Example 9

3 g of biphephos, prepared as in Example 1, were suspended in 18 ml of acetone and stirred for 30 min. at room temperature. The solid was then filtered off over a G3 protective-glass frit and after-washed with 9 ml of acetone. The colourless solid was dried for 16 hours at 10⁻¹ mbar and then analysed. 2.2 g of biphephos were obtained with a total chlorine content of 240 ppm.

### Example 10

### Recrystallization of Biphephos

50 g of biphephos, prepared as in Example 1, were suspended in 250 g of ethyl acetate. The mixture was then heated to boiling. 1 g of activated carbon was added, and the hot mixture was filtered over a G3 glass frit. 20 g of n-heptane were then added and the mother liquor was left to cool to room temperature, during which biphephos precipitated out. This was filtered off over a further G3 glass frit and after-washed with 50 ml of ethyl acetate. The biphephos obtained was then dried in a vacuum drying cabinet. 41 g of biphephos with a total chlorine content of 62 ppm were obtained.

1. A process for purifying biphephos, the process comprising:
washing out the biphephos with at least one solvent selected from the group consisting of ethyl acetate, anisole, ortho-xylene, toluene, acetone, 2-propanol and C5-C10-alkane,
recrystallizing the biphephos from the solvent, or both.

2. The process according to claim 1, wherein the solvent is acetonitrile-free.

3. The process according to claim 1, further comprising removing acetonitrile from the solvent.

4. The process according to claim 1, further comprising:
dissolving the biphephos in the solvent,
removing insoluble constituents by filtration,
precipitating out or crystallizing out the biphephos, and by cooling the solvent
optionally precipitating out or crystallizing out further biphephos by adding a C5-C10-alkane.

5. The process according to claim 4, wherein the solvent has a temperature of more than 50° C. and the insoluble constituents are removed by hot filtration.

6. The process according to claim 1, wherein the biphephos before the recrystallizing has a total chlorine content of up to 5000 ppm and after the recrystallizing has a total chlorine content of less than 500 ppm.

7. The process according to claim 1, comprising recrystallizing the biphephos from the solvent,
wherein the solvent comprises up to 20% by weight of n-heptane and at least 50% by weight of ortho-xylene.

8. The process according to claim 1, comprising recrystallizing the biphephos from the solvent,
wherein the solvent comprises up to 10% by weight of n-heptane and at least 90% by weight of ethyl acetate.

9. The process according to claim 1, further comprising, after the recrystallizing, isolating the biphephos, and, optionally, drying the biphephos.

10. (canceled)

11. The process according to claim 1, further comprising removing acetonitrile from the solvent by distillation.

12. The process according to claim 4, further comprising precipitating out or crystallizing out further biphephos by adding a C5-C10 alkane.

13. The process according to claim 1, wherein the biphephos before recrystallizing has a total chlorine content of up to 4000 ppm, and after the recrystallizing has a total chlorine content of less than 250 ppm.

14. The process according to claim 1, wherein the biphephos before recrystallizing has a total chlorine content of up to 3000 ppm, and after the recrystallizing has a total chlorine content of less than 100 ppm.

15. The process according to claim 1, wherein the biphephos before recrystallizing has a total chlorine content of up to 2000 ppm, and after the recrystallizing has a total chlorine content of less than 50 ppm.

16. The process according to claim 1, further comprising, after the recrystallizing, isolating the biphephos by filtering off, and optionally drying the biphephos.

17. The process according to claim 9, comprising drying the biphephos.

18. The process according to claim 1, comprising washing out the biphephos with the solvent.

19. The process according to claim 1, comprising recrystallizing the biphephos from the solvent.

20. The process according to claim 1, comprising both washing the biphephos with the solvent and recrystallizing the biphephos from the solvent.
